(19) United States
(12) Patent Application Publication
(10) Pub. No.: US 2015/0168778 A1
(43) Pub. Date: Jun. 18, 2015

(54) LIQUID CRYSTAL DISPLAY

(71) Applicant: Samsung Display Co., Ltd., Yongin-City (KR)

(72) Inventor: YongHwan Shin, Yongin-si (KR)

(21) Appl. No.: 14/336,736

(22) Filed: Jul. 21, 2014

(30) Foreign Application Priority Data
Dec. 18, 2013 (KR) 10-2013-0158435

(51) Int. Cl. G02F 1/1335; G02F 1/13363

(52) U.S. Cl. CPC G02F 1/133528; G02F 1/13363; G02F 2413/01

(57) ABSTRACT

A liquid crystal display (LCD) is disclosed. In one aspect, the LCD includes a first polarization member having a first absorption axis substantially parallel to a first direction, a second polarization member formed below the first polarization member, a liquid crystal layer interposed between the first and second polarization members, and a phase compensation layer interposed between the first and second polarization members. The second polarization member has a second absorption axis substantially parallel to a second direction and a third absorption axis substantially parallel to a third direction. The second direction is substantially perpendicular to the first direction. The third direction is substantially perpendicular to the first and second directions. The liquid crystal layer includes substantially vertically-oriented liquid crystal molecules

### INCORPORATION BY REFERENCE TO ANY PRIORITY APPLICATIONS

This U.S. non-provisional patent application claims priority under 35 U.S.C. §119 to Korean Patent Application No. 10-2013-0158435, filed on Dec. 18, 2013, in the Korean Intellectual Property Office, the entire contents of which are hereby incorporated by reference.

### BACKGROUND

1. Field

The described technology generally relates to a liquid crystal display.

2. Description of the Related Technology

Electronic products, such as smart phones, digital cameras, notebook computers, navigation systems, and smart televisions, have an image display device for displaying an image to a user.

In general, a thin and light flat-panel display is widely used for the display device, such as a liquid crystal display (LCD), an organic light-emitting display (OLED), a plasma display, and an electrophoresis display.

LCD technology includes a liquid crystal layer interposed between two substrates. An electric field applied to the liquid crystal layer is controlled to adjust the amount of light passing through the two substrates and display the desired image.

### SUMMARY OF CERTAIN INVENTIVE ASPECTS

One inventive aspect is a liquid crystal display with improved display quality.

Another aspect is a liquid crystal display device that includes a first polarization member having a first absorption axis parallel to a first direction, a second polarization member disposed to face the first polarization member, the second polarization member having a second absorption axis parallel to a second direction perpendicular to the first direction and a third absorption axis parallel to a third direction perpendicular to the first and second direction and thereby absorbing light leakage, which results from a distortion of the first and second absorption axes by a change in viewing angle, a liquid crystal layer interposed between the first and second polarization members to include vertically-oriented liquid crystal molecules, a phase compensation layer interposed between the first and second polarization members to compensate phase delay caused by the liquid crystal layer, and a backlight unit providing light to the liquid crystal layer through at least one of the first and second polarization members.

In example embodiments, the second polarization member can include a horizontal polarization member having the second absorption axis and a vertical polarization member having the third absorption axis.

In example embodiments, the first polarization member can include a first polarizer, the horizontal polarization member can include a second polarizer, and the vertical polarization member can include a third polarizer, each of the first through third polarizers is a rod-like polarizer.

In example embodiments, the first polarizer can be configured to meet a condition of ky1>kx1≈kz1, the second polarizer can be configured to meet a condition of kx1>ky1≈kz1, and the third polarizer can be configured to meet a condition of kz1>kx1≈ky1, where kx1, ky1, and kz1 are components in the first to third directions, respectively, of extinction coefficient of the first polarizer, kx2, ky2, and kz2 are components in the first to third directions, respectively, of extinction coefficient of the second polarizer, and kx3, ky3, and kz3 are components in the first to third directions, respectively, of extinction coefficient of the third polarizer.

In example embodiments, the second polarization member can be disposed to face the backlight unit, and the liquid crystal layer can receive the light through the second polarization member.

In example embodiments, the horizontal polarization member can be disposed to face the backlight unit, and the vertical polarization member can be interposed between the horizontal polarization member and the liquid crystal layer.

In example embodiments, the vertical polarization member can be disposed to face the backlight unit, and the horizontal polarization member can be interposed between the vertical polarization member and the liquid crystal layer.

In example embodiments, the first polarization member can be disposed to face the backlight unit, and the liquid crystal layer can receive the light through the first polarization member.

In example embodiments, the second polarization member can include a disc-like polarizer.

In example embodiments, the disc-like polarizer can be configured to meet a condition of kx1≈kz1>ky1, where kx1, ky1, and kz1 are components in the first to third directions, respectively, of extinction coefficient of the disc-like polarizer.

In example embodiments, the second polarization member can be disposed to face the backlight unit, and the liquid crystal layer can receive the light through the second polarization member.

In example embodiments, the first polarization member can be disposed to face the backlight unit, and the liquid crystal layer can receive the light through the first polarization member.

In example embodiments, the phase compensation layer can be interposed between the second polarization member and the liquid crystal layer.

In example embodiments, the phase compensation layer can be a uniaxial film.

In example embodiments, the uniaxial film can be a negative C plate.

In example embodiments, the liquid crystal molecule can have a negative permittivity.

Another aspect is a liquid crystal display (LCD), comprising a first polarization member, a second polarization member, a liquid crystal layer, a phase compensation layer, and a backlight unit. The first polarization member has a first absorption axis substantially parallel to a first direction. The second polarization member is formed below the first polarization member, wherein the second polarization member has a second absorption axis substantially parallel to a second direction and a third absorption axis substantially parallel to a third direction. The second direction is substantially perpendicular to the first direction, and the third direction is substantially perpendicular to the first and second directions. The liquid crystal layer is interposed between the first and second polarization members, wherein the liquid crystal layer includes substantially vertically-oriented liquid crystal molecules. The phase compensation layer is interposed between the first and second polarization members. The backlight unit is configured to provide light towards the liquid crystal layer.

In the above LCD, the second polarization member comprises a horizontal polarization member having the second absorption axis and a vertical polarization member having the third absorption axis. In the above LCD, the first polarization member comprises a first polarizer, wherein the horizontal polarization member comprises a second polarizer, wherein the vertical polarization member comprises a third polarizer, and wherein each of the first through third polarizers is a rod-like polarizer.

In the above LCD, the first polarizer is configured to satisfy the relationship of ky1>kx1≈kz1, wherein kx1, ky1, and kz1 are components in the first to third directions, respectively, of the extinction coefficient of the first polarizer. In the above LCD, the second polarizer is configured to satisfy the relationship of kx2>ky2≈kz2, wherein kx2, ky2, and kz2 are components in the first to third directions, respectively, of the extinction coefficient of the second polarizer. In the above LCD, the third polarizer is configured to satisfy the relationship of kz3>kx3≈ky3, wherein kx3, ky3, and kz3 are components in the first to third directions, respectively, of the extinction coefficient of the third polarizer.

In the above LCD, the second polarization member is closer to the backlight unit than the first polarization member, and the liquid crystal layer is configured to receive the light from the backlight unit through the second polarization member. In the above LCD, the horizontal polarization member is formed closer the backlight unit than the vertical polarization member, and the vertical polarization member is interposed between the horizontal polarization member and the liquid crystal layer.

In the above LCD, the vertical polarization member is closer to the backlight unit than the horizontal polarization member, and the horizontal polarization member is interposed between the vertical polarization member and the liquid crystal layer.

In the above LCD, the first polarization member is closer to the backlight unit than the second polarization member, and the liquid crystal layer is configured to receive the light from the backlight unit through the first polarization member.

In the above LCD, the second polarization member comprises a disc-like polarizer. In the above LCD, the disc-like polarizer is configured to satisfy the relationship of kx1≈kz1>ky1, wherein kx1, ky1, and kz1 are components in the first to third directions, respectively, of the extinction coefficient of the disc-like polarizer.

In the above LCD, the second polarization member is closer to the backlight unit than the first polarization member, and the liquid crystal layer is configured to receive the light from the backlight unit through the second polarization member.

In the above LCD, the first polarization member is closer to the backlight unit than the second polarization member, and the liquid crystal layer is configured to receive the light from the backlight unit through the first polarization member.

In the above LCD, the phase compensation layer is interposed between the second polarization member and the liquid crystal layer.

In the above LCD, the phase compensation layer is a uniaxial film. In the above LCD, the uniaxial film is a negative C plate. In the above LCD, the liquid crystal molecule has a negative permittivity.

Another aspect is a liquid crystal display (LCD), comprising a first polarization member, a second polarization member, a liquid crystal layer, and a phase compensation layer. The first polarization member has a first absorption axis substantially parallel to a first direction. The second polarization member is formed below the first polarization member, wherein the second polarization member has a second absorption axis substantially parallel to a second direction and a third absorption axis substantially parallel to a third direction, wherein the second direction is substantially perpendicular to the first direction, and wherein the third direction is substantially perpendicular to the first and second direction. The liquid crystal layer is interposed between the first and second polarization members, wherein the liquid crystal layer includes substantially vertically-oriented liquid crystal molecules. The phase compensation layer is interposed between the first and second polarization members.

The above LCD further comprises a backlight unit configured to provide light towards the liquid crystal layer, wherein the phase compensation layer is a uniaxial film, and wherein the uniaxial film is a negative C plate. In the above LCD, the first polarization member comprises a first polarizer, wherein the second polarization member comprises a horizontal polarization member having the second absorption axis and a vertical polarization member having the third absorption axis, wherein the horizontal polarization member comprises a second polarizer, wherein the vertical polarization member comprises a third polarizer, and wherein each of the first through third polarizers is a rod-like polarizer.

In the above LCD, the first polarizer is configured to satisfy the relationship of ky1>kx1≈kz1, wherein kx1, ky1, and kz1 are components in the first to third directions, respectively, of the extinction coefficient of the first polarizer. In the above LCD, the second polarizer is configured to satisfy the relationship of kx2>ky2≈kz2, wherein kx2, ky2, and kz2 are components in the first to third directions, respectively, of the extinction coefficient of the second polarizer. In the above LCD, the third polarizer is configured to satisfy the relationship of kz3>kx3≈ky3, wherein kx3, ky3, and kz3 are components in the first to third directions, respectively, of the extinction coefficient of the third polarizer.

### BRIEF DESCRIPTION OF THE DRAWINGS

FIG. 1 is a sectional view of a liquid crystal display according to example embodiments.

FIG. 2 is a plan view illustrating the liquid crystal display panel of FIG. 1.

FIG. 3 is a sectional view taken along line I-I′ of FIG. 2.

FIG. 4 is a schematic diagram provided to explain an extinction coefficient of a first polarizer.

FIG. 5 is a schematic diagram provided to explain an index ellipsoid of a liquid crystal molecule of a liquid crystal layer.

FIG. 6 is a schematic diagram provided to explain an index ellipsoid of a phase compensation layer.

FIG. 7 is a schematic diagram provided to explain an extinction coefficient of a second polarizer.

FIG. 8 is a schematic diagram provided to explain an extinction coefficient of a third polarizer.

FIG. 9 is an exploded sectional view illustrating the liquid crystal display of FIG. 1.

FIG. 10 is a sectional view of a liquid crystal display according to other example embodiments.

FIG. 11 is a schematic diagram provided to explain an extinction coefficient of a disc-like polarizer.

FIG. 12 is an exploded sectional view illustrating the liquid crystal display of FIG. 10.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements can be reduced or exaggerated for clarity. The use of similar or identical reference numbers in the various drawings is intended to indicate the presence of a similar or identical element or feature.

### DETAILED DESCRIPTION OF CERTAIN INVENTIVE EMBODIMENTS

Example embodiments of the described technology will now be described more fully with reference to the accompanying drawings, in which example embodiments are shown. Example embodiments of the described technology can, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. can be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the described technology belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In this disclosure, the term “substantially” means completely, almost completely or to any significant degree. Moreover, “formed on” can also mean “formed over”.

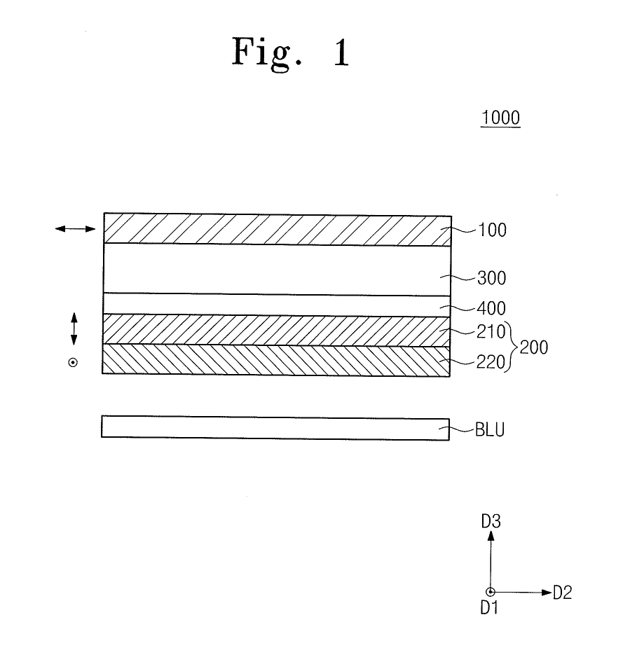

FIG. 1 is a sectional view of a liquid crystal display (LCD) 1000 according to example embodiments.

Referring to FIG. 1, the liquid crystal display 1000 can include a first polarization member 100, a second polarization member 200, a liquid crystal display panel 300, a phase compensation layer 400, and a backlight unit BLU.

The liquid crystal display 1000 can display visual information, such as text, video, picture, two-dimensional, three-dimensional image, etc. Hereinafter, such visual information is included in “image”.

The shape or structure of the liquid crystal display 1000 can be variously changed. In some embodiments, the liquid crystal display 1000 is shaped like a rectangular plate. In other words, two adjacent sides of the liquid crystal display 1000 can be substantially parallel to first and second directions D1 and D2 that are substantially perpendicular to each other. Top and bottom surfaces of the LCD 1000 can be spaced apart from each other in a third direction D3 that is substantially orthogonal to the first and second directions D1 and D2. The first direction D1 can be substantially normal to the section shown in FIG. 1.

In some embodiments, light is generated in the backlight unit BLU and is transmitted to the liquid crystal display panel 300. The backlight unit BLU can be formed below the liquid crystal display panel 300.

The backlight unit BLU can include a light source, a light-guiding plate, and an optical member. The light can be generated from the light source (e.g., a light-emitting diode (LED) that emits white light). The light-guiding plate can transform the light generated from the light source to plane light. The plane light can be incident into the liquid crystal display panel 300 through the optical member, which can improve uniformity in brightness of the plane light incident thereto.

In some embodiments, the second polarization member 200, the phase compensation layer 400, the liquid crystal display panel 300, and the first polarization member 100 can be sequentially stacked along the third direction D3. In other words, the first polarization member 100 can be formed on the liquid crystal display panel 300, the phase compensation layer 400 can be formed below the liquid crystal display panel 300, and the second polarization member 200 can be formed below the phase compensation layer 400.

The light transmitted from the backlight unit BLU can be used to display the image on the liquid crystal display panel 300. For example, the image can be displayed using the light passing through the second polarization member 200, the liquid crystal display panel 300, and the first polarization member 100.

The liquid crystal display panel 300 can include a plurality of pixels and an interconnection structure. The pixels can be electrically connected to the interconnection structure to receive signals through the interconnection structure. The pixels can operate in response to the signal, thereby displaying the image.

The disposition or arrangement of the first polarization member 100, the second polarization member 200, and the phase compensation layer 400 is not limited to the aforementioned example and can be variously modified. For example, the second polarization member 200 can be formed on the liquid crystal display panel 300. The phase compensation layer 400 can be interposed between the liquid crystal display panel 300 and the second polarization member 200. The first polarization member 100 can be formed below the liquid crystal display panel 300. In this case, the light transmitted from the backlight unit BLU can be incident into the liquid crystal display panel 300 through the first polarization member 100 and be emitted through the second polarization member 200 to display the image.

The first polarization member 100 can be configured in such a way that only light that has a polarization state substantially parallel to the first and third directions D1 and D3 passes therethrough. (Hereinafter, the first and third directions D1 and D3 can be referred to as “x-axis” and “z-axis”, respectively.)

Here, the incident light can be natural or unpolarized light, which is composed of a rapidly varying succession of different polarization states (e.g., linearly-polarized states and circularly-polarized states). The circularly-polarized states include left-circularly polarized states and right-circularly polarized states.

The first polarization member 100 can have a first absorption axis substantially parallel to the second direction D2 (hereinafter, the second direction D2 can be referred to as a “y-axis”). In other words, the first polarization member 100 can absorb a y-polarized fraction of the incident light substantially parallel to the first absorption axis and pass x- and z-polarized fractions of the incident light substantially parallel to the x- and z-axes.

In general, a rod-like polarizer can be fabricated by, for example, adsorbing a dichroic coloring material (e.g., iodine) or a dichroic dye onto a resin film and then stretching and orientating the resin film along the first direction D1. Accordingly, the rod-like polarizer can have a rod shape extending along the stretching direction.

The phase compensation layer 400 can compensate a phase difference of light, which can occur when the light passes through the liquid crystal layer 300. The phase compensation layer 400 can make it possible to prevent light leakage from occurring in the liquid crystal display 1000, thereby improving t viewing angles of the liquid crystal display 1000. For example, the phase compensation layer 400 can cause a delay in the phase of light passing therethrough (hereinafter, referred to as “compensation phase difference”), thereby minimizing or substantially eliminating the phase difference that occurs in the liquid crystal display panel 300.

The compensation phase difference can be given as a function of the refractive index of the phase compensation layer 400 and the thickness of the phase compensation layer 400.

The second polarization member 200 can receive the light transmitted from the backlight unit BLU and allow the y-polarized fraction to be transmitted toward the phase compensation layer 400.

The second polarization member 200 can have a second absorption axis substantially parallel to the x-axis and a third absorption axis substantially parallel to the z-axis. Accordingly, the second polarization member 200 can absorb the x- and z-polarized fractions while the second polarization member 200 does not absorb the y-polarized fraction.

In some embodiments, the second polarization member 200 includes a horizontal polarization member 220 and a vertical polarization member 210. The horizontal polarization member 220 is formed below the phase compensation layer 400. The vertical polarization member 210 is interposed between the phase compensation layer 400 and the horizontal polarization member 220.

The disposition or arrangement of the vertical polarization member 210 and the horizontal polarization member 220 is not limited to the aforementioned example and be variously modified. For example, the vertical polarization member 210 can be formed below the phase compensation layer 400, and the horizontal polarization member 220 can be interposed between the phase compensation layer 400 and the vertical polarization member 210.

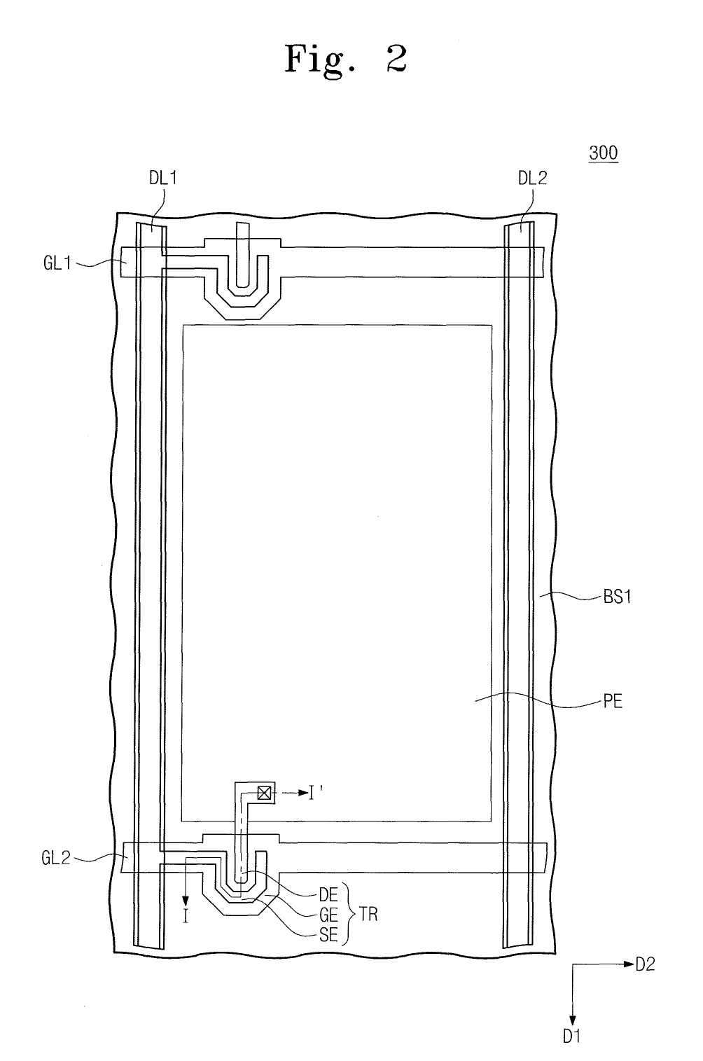

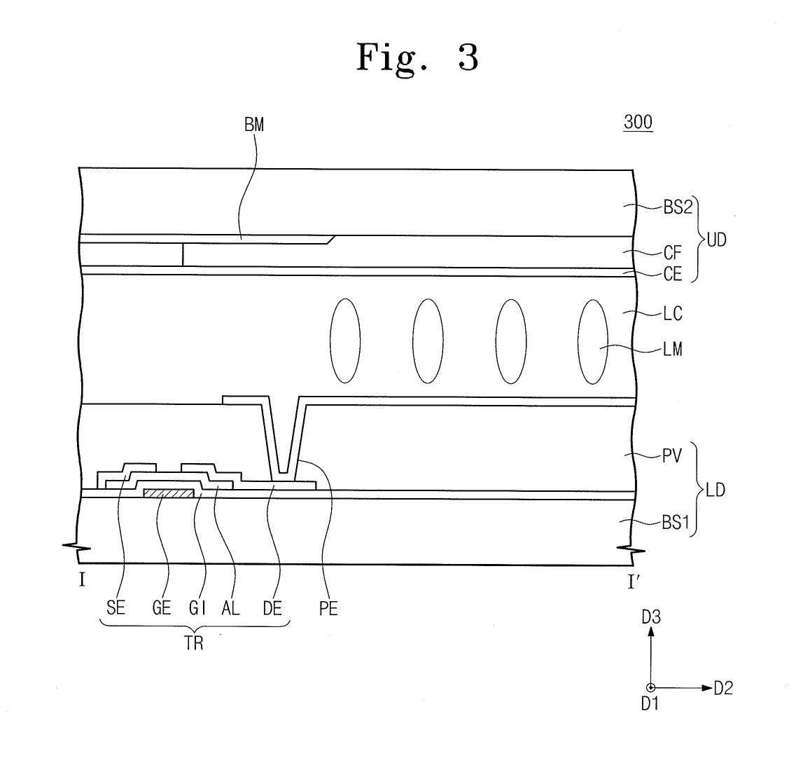

FIG. 2 is a plan view illustrating the liquid crystal display panel 300 of FIG. 1. FIG. 3 is a sectional view taken along line I-I′ of FIG. 2. In the liquid crystal display panel 300, the pixels can be formed to have substantially the same structure, and thus, one of the pixels is illustrated as an example with reference to FIG. 2.

Referring to FIGS. 2 and 3, the liquid crystal display panel 300 can include an upper plate UD, a lower plate LD, and a liquid crystal layer LC.

The lower plate LD can include a first base substrate BS1, a gate line, a data line, a thin-film transistor TR, an insulating layer PV, and a pixel electrode PE.

The first base substrate BS1 can serve as a base element of the lower plate LD. The first base substrate BS1 can be formed of a transparent material (e.g., glass or plastic).

The gate line can include first and second gate lines GL1 and GL2. The first and second gate lines GL1 and GL2 can be formed on the first base substrate BS1 to extend along the second direction D2 and be spaced apart from each other in the first direction D1. Each of the first and second gate lines GL1 and GL2 can be electrically connected to the thin-film transistor TR so as to transmit a gate signal to the thin-film transistor TR.

The data line can include first and second data lines DL1 and DL2. The first and second data lines DL1 and DL2 can be spaced apart and electrically separated from the gate line. The first and second data lines DL1 and DL2 can be formed on the first base substrate BS1 to extend along the first direction D1 and be spaced apart from each other in the second direction D2. Each of the first and second data lines DL1 and DL2 can be electrically connected to the thin-film transistor TR so as to transmit a data signal to the thin-film transistor TR.

The thin-film transistor TR can be turned on or off by the gate signal. When the thin-film transistor TR is turned on, the data signal can be output to the pixel electrode PE through the thin-film transistor TR.

In example embodiments, the thin-film transistor TR includes a gate electrode GE, a semiconductor layer AL, a source electrode SE, and a drain electrode DE. The gate electrode GE can be electrically connected to the first gate line GL1. The gate insulating layer GI can substantially cover the gate electrode GE. The semiconductor layer AL can be formed on the gate electrode GE with the gate insulating layer GI interposed therebetween. The gate insulating layer GI can substantially electrically separate the gate electrode GE from the semiconductor layer AL. The source electrode SE can be electrically connected to the first data line DL1 so as to be in electrical connection with the semiconductor layer AL. The drain electrode DE can be spaced apart from the source electrode SE and be electrically connected to the semiconductor layer AL.

The insulating layer PV can substantially cover the thin-film transistor TR. Contact holes can be formed in the insulating layer PV to expose the drain electrode DE.

The pixel electrode PE can be formed on the insulating layer PV and be electrically connected to the drain electrode DE through the contact hole. Although not shown, the pixel electrode PE can include a pattern that divides the pixel electrode PE into a plurality of domains. Liquid crystal molecules LM in a domain can be re-arranged in different directions by an electric field applied thereto. Accordingly, the presence of the domains makes it possible to improve the viewing angle of the liquid crystal display panel 300. The liquid crystal layer LC can be interposed between the lower and upper plates LD and UD. The liquid crystal layer LC can include the liquid crystal molecule LM having a dielectric anisotropy and an optical anisotropy. In some embodiments, the liquid crystal molecule LM can have a negative dielectric anisotropy. Accordingly, when the liquid crystal layer LC is applied with an electric field, the liquid crystal molecule LM can be re-arranged in such a way that a short axis thereof is substantially perpendicular to the applied electric field. The liquid crystal molecule LM can be formed between the lower plate LD and the upper plate UD and be oriented to be substantially perpendicular to the lower and upper plates LD and UD (e.g., homeotropic).

Here, the term “re-arranged” can be used to describe the liquid crystal molecules LM rotating on an axis defined by the second direction D2 or at an angle in respect to the third direction D3.

The upper plate UD can include a second base substrate BS2, a color filter CF, a black matrix BM, and a common electrode CE.

The second base substrate BS2 can serve as a base element of the upper plate UD. The second base substrate BS2 can be formed of a transparent material (e.g., glass or plastic).

The black matrix BM can substantially block light. The black matrix BM can be formed to face the pixel electrode PE and include an opening region having substantially the same shape as the pixel electrode PE. The color filter CF can be formed on the opening region. Light passing through the color filter CF can be filtered to display color (e.g., red, green, or blue).

The common electrode CE can be formed on the second base substrate BS2 to apply the electric field to the liquid crystal layer LC in conjunction with the pixel electrode PE.

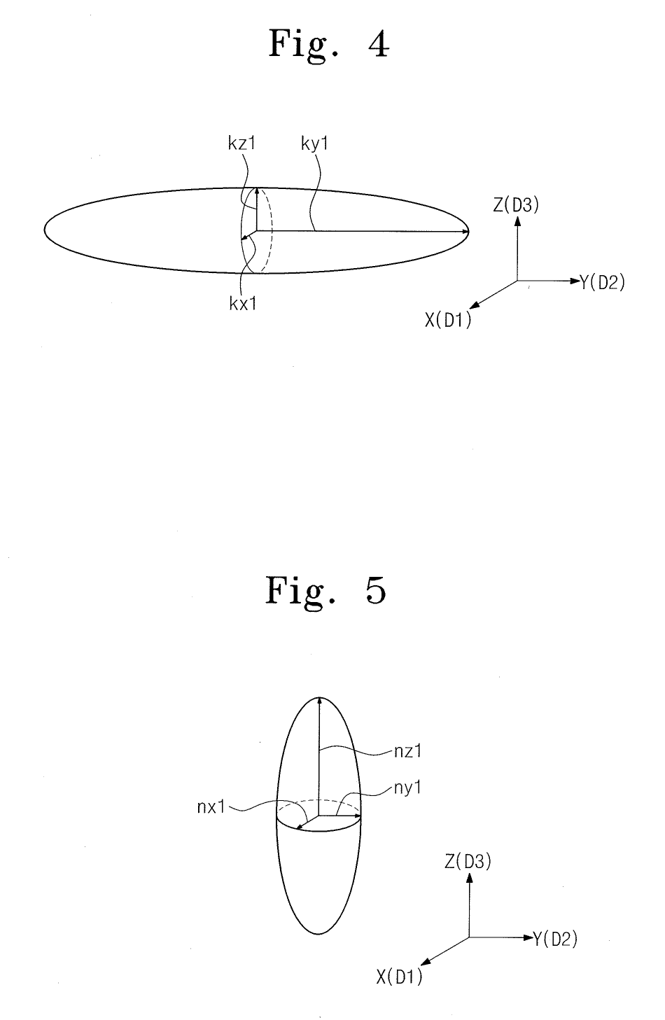

FIG. 4 is a schematic diagram formed to explain an extinction coefficient of a first polarizer, which can be formed in the first polarization member described with reference to FIG. 1.

Referring to FIG. 4, the first polarization member 100 can include a first polarizer. In the present embodiment, the first polarizer can be the rod-like polarizer.

In general, optical characteristics of an absorptive medium can be described by a complex refractive index \hat{n}, which can be given by:

\hat{n}=n±ik [EQUATION]

where n is a real refractive index (hereafter, refractive index(n)) which is the real part of the complex refractive index \hat{n}, and k is the extinction coefficient which is the imaginary part of the complex refractive index \hat{n}. Accordingly, when light propagates through the absorptive medium by a propagation distance d, a phase of the light can be delayed depending on the refractive index n and the propagation distance d. An amplitude of the light can be exponentially decreased depending on the extinction coefficient k and the propagation distance d.

X-, y-, and z-extinction coefficients will be used to denote x-, y-, and z-components of the extinction coefficient k which are given in the first direction D1 substantially parallel to the x-axis, the second direction D2 substantially parallel to the y-axis, and the third direction D3 substantially parallel to the z-axis, respectively.

Furthermore, x-, y-, and z-axis refractive indices will be used to denote x-, y-, and z-components of the refractive index n, which are given along x-, y-, and z-axes, respectively.

In the present embodiment, a first x-axis extinction coefficient kx1, a first y-axis extinction coefficient ky1, and a first z-axis extinction coefficient kz1 will be used to denote x-, y-, and z-components of the extinction coefficient k of the first polarizer.

The first y-axis extinction coefficient ky1 can be greater than the first x-axis extinction coefficient kx1 and the first z-axis extinction coefficient kz1. Accordingly, most of the y-polarized fraction of light, which can be incident to the first polarization member 100, can be absorbed by the first polarizer.

By contrast, because the first x-axis extinction coefficient kx1 and the first z-axis extinction coefficient kz1 are small, the x- and z-polarized fractions of the incident light can be substantially neglected. Accordingly, most of the x- and z-polarized fractions can pass through the first polarization member 100.

Although not shown, the first polarization member 100 can further include a protection member and a supporting member.

The protection member can substantially prevent the first polarization member 100 from being polluted or damaged by the environment. The protection member can be formed on at least one of surfaces of the first polarization member 100. The protection member can be formed of an optically-transparent material, which does not exhibit double refraction and has a high mechanical strength. The protection member can be formed at least partially of bi-axial-stretch polyolefin film, polyester film, thermoplastic norbornene resin film, polycarbonate film, polybutyleneterephthalate film or a combination thereof.

The supporting member can support the first polarization member 100. For example, the supporting member can be formed on top and bottom surfaces of the first polarization member 100. The supporting member can be formed at least partially of cellulosic polymer, for example, tri acetate cellulose (TAC).

FIG. 5 is a schematic diagram provided to generally explain an index ellipsoid of a liquid crystal molecule of a liquid crystal layer.

Referring to FIGS. 3 and 5, x, y, and z components of the refractive index of the liquid crystal molecule LM will be referred to as “first x-axis refractive index nx1”, “first y-axis refractive index ny1”, and “first z-axis refractive index nz1”.

In the present embodiment, the first z-axis refractive index nz1 can be greater than the first x-axis refractive index nx1 and the first y-axis refractive index ny1. An optic axis of the liquid crystal molecule LM can be parallel to the z-axis direction, and the first x-axis refractive index nx1 can be substantially the same as the first y-axis refractive index ny1. Accordingly, when incident light is substantially perpendicular to the optic axis, phase of the light is not delayed.

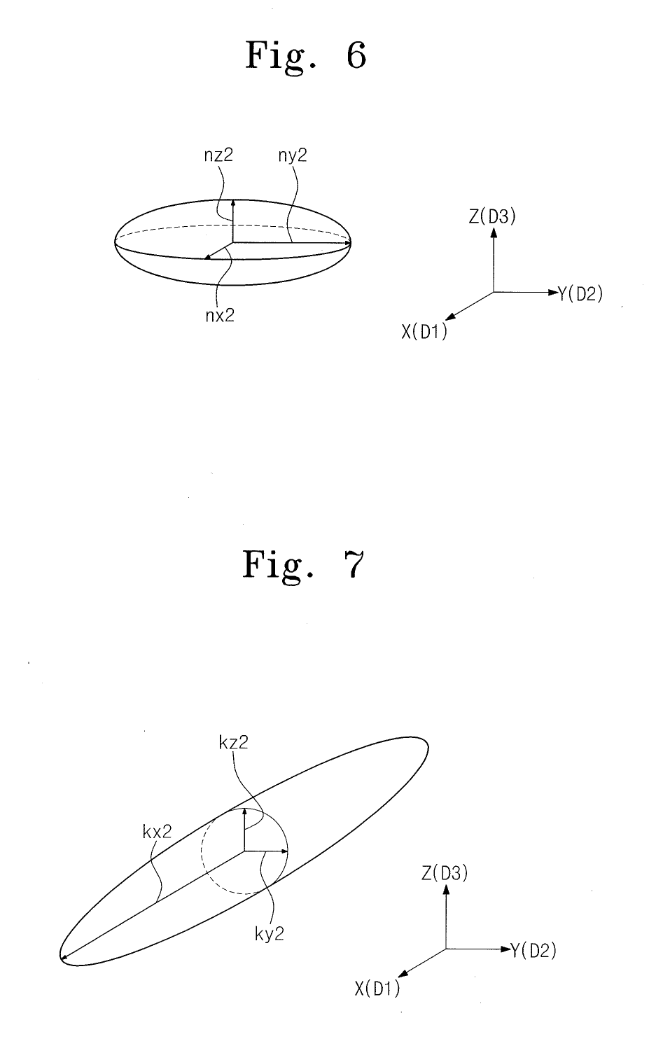

FIG. 6 is a schematic diagram provided to explain an index ellipsoid of the phase compensation layer 400 of FIG. 1.

Referring to FIG. 6, the phase compensation layer 400 can be an uniaxial film. For example, the phase compensation layer 400 can be a negative C plate. Here, x, y, and z components of refractive index of the phase compensation layer 400 will be referred to as “second x-axis refractive index nx2”, “second y-axis refractive index ny2”, and “second z-axis refractive index nz2”, respectively.

The second x-axis refractive index nx2 can be substantially the same as the second y-axis refractive index ny2. The second z-axis refractive index nz2 can be less than the second x-axis refractive index nx2 and the second y-axis refractive index ny2.

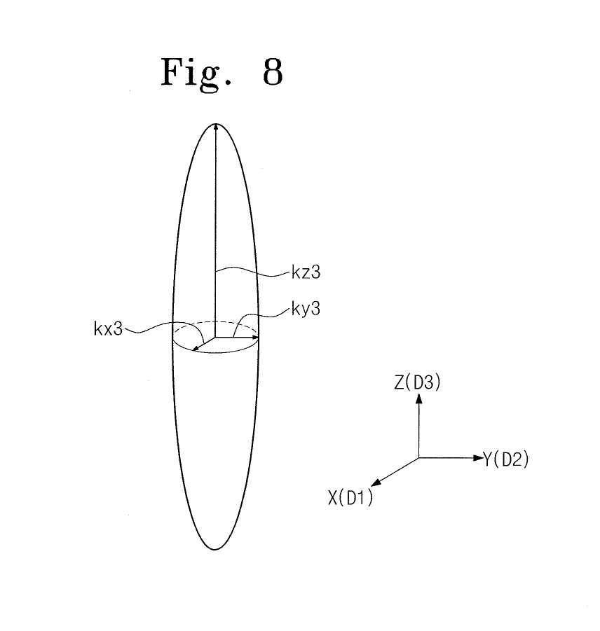

FIG. 7 is a schematic diagram provided to explain an extinction coefficient of a second polarizer, which can be included in the horizontal polarization member 220 of FIG. 1. FIG. 8 is a schematic diagram provided to explain an extinction coefficient of a third polarizer, which can be formed in the vertical polarization member 210 of FIG. 1.

Referring to FIG. 7, the horizontal polarization member 220 can have the second absorption axis. In other words, the horizontal polarization member 220 can absorb the x-polarized fraction and pass the y- and z-polarized fractions.

The horizontal polarization member 220 can include a second polarizer. In the present embodiment, the second polarizer can be the rod-like polarizer.

Here, x, y, and z components of the extinction coefficient of the second polarizer will be referred to as “second x-axis extinction coefficient kx2”, “second y-axis extinction coefficient ky2”, and “second z-axis extinction coefficient kz2”, respectively.

The second x-axis extinction coefficient kx2 can be greater than the second y-axis extinction coefficient ky2 and the second z-axis extinction coefficient kz2. Accordingly, most of the x-polarized fraction of light, which can be incident to the horizontal polarization member 220, can be absorbed by the second polarizer.

By contrast, because the second y-axis extinction coefficient ky2 and the second z-axis extinction coefficient kz2 are small, the y- and z-polarized fractions of the incident light can be substantially neglected. Accordingly, most of the y- and z-polarized fractions of the incident light can pass through the horizontal polarization member 220.

Although not shown, the horizontal polarization member 220 can further include the protection member and the supporting member. The protection member can be formed to cover at least one of surfaces of the horizontal polarization member 220, and thus, it can substantially prevent the horizontal polarization member 220 from being polluted or damaged by the environment.

The supporting member can be formed on top and bottom surfaces of the horizontal polarization member 220 so as to support the horizontal polarization member 220.

Referring to FIG. 8, the vertical polarization member 210 can have the third absorption axis. In other words, the vertical polarization member 210 can absorb the z-polarized fraction and not to absorb the x- and y-polarized fractions.

The vertical polarization member 210 can include a third polarizer. In the present embodiment, the third polarizer can be the rod-like polarizer.

Here, x, y, and z components of the extinction coefficient of the third polarizer will be referred to as “third x-axis extinction coefficient kx3”, “third y-axis extinction coefficient ky3”, and “third z-axis extinction coefficient kz3”, respectively.

The third z-axis extinction coefficient kz3 can be greater than the third x-axis extinction coefficient kx3 and the third y-axis extinction coefficient ky3. Accordingly, most of the z-polarized fraction of light can be absorbed by the third polarizer.

By contrast, because the third x-axis extinction coefficient kx3 and the third y-axis extinction coefficient ky3 are small, the x- and y-polarized fractions of the incident light to be absorbed by the third polarizer can be substantially neglected. Accordingly, most of the x- and y-polarized fractions of the incident light can pass through the vertical polarization member 210.

Although not illustrated, the vertical polarization member 210 can include the protection member and the supporting member. The protection member can be formed on at least one of surfaces of the vertical polarization member 210, and thus, it can substantially prevent the vertical polarization member 210 from being polluted or damaged by the environment.

The supporting member can be formed on top and bottom surfaces of the vertical polarization member 210 so as to support the vertical polarization member 210.

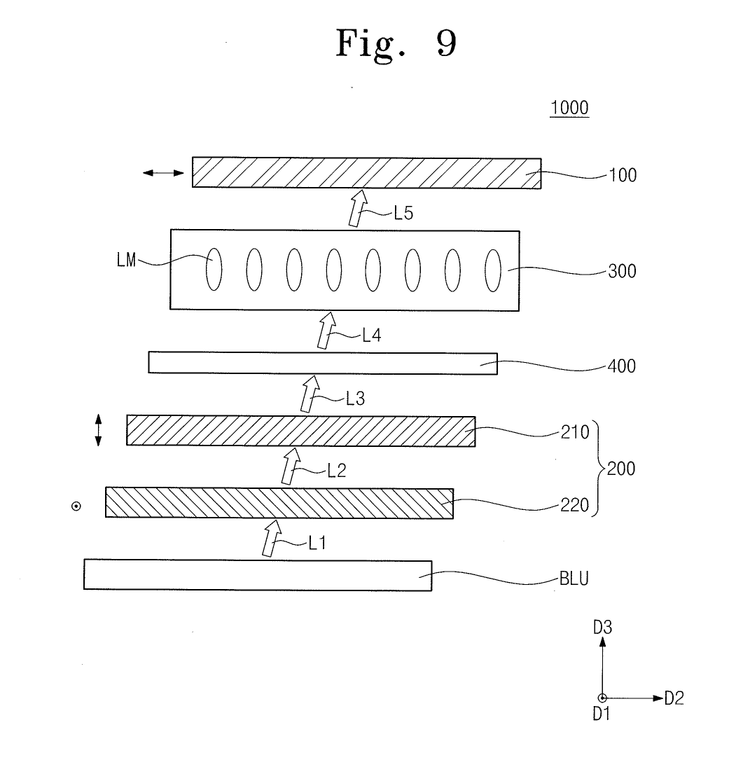

FIG. 9 is an exploded sectional view illustrating the liquid crystal display 1000 of FIG. 1.

Hereinafter, operation of the liquid crystal display 1000 will be described with reference to FIGS. 4 through 9. When the liquid crystal display 1000 displays a black tone image, the liquid crystal molecule LM can be arranged in such a way that a longitudinal axis thereof is substantially parallel to the z-axis.

A user can be located at various positions to see an image on the liquid crystal display 1000, and thus, the user can see the image at various angles.

For example, the user can be positioned substantially directly facing the image. In other words, the user can be positioned on a first path substantially parallel to the z-axis to see the image. In this case, light emitted from the backlight unit BLU can pass through the second polarization member 200 to be linearly polarized in the x-axis. The linearly polarized light can have an unchanged polarization after the linearly polarized light passes through the liquid crystal display panel 300. This is because the linearly polarized light propagates along the first path or along a second path substantially parallel to an optic axis of the liquid crystal molecules LM. Accordingly, the light passing through the liquid crystal display panel 300 can be substantially blocked by the first polarization member 100, and thus, the black tone image can be seen by the user.

Alternatively, the user can be positioned to see the image at an angle (hereinafter, referred to as “lateral viewing”). In other words, the user can be positioned on a slanted path at an angle in respect to the third direction D3 to see the image. In this case, the user can see the image displayed through the first to fifth lights L1-L5. The first to fifth lights L1-L5 can propagate along the slanted path.

The first light L1 can be emitted from the backlight unit BLU and incident into the horizontal polarization member 220 at the angle. The first light L1 can be the unpolarized light, which is composed of a rapidly varying succession of different polarization states (e.g., linearly-polarized states and circularly-polarized states).

The first light L1 can be filtered by the horizontal polarization member 220, thereby forming the second light L2 propagating toward the vertical polarization member 210. Because the horizontal polarization member 220 absorbs the x-polarized fraction of the first light L1, the second light L2 can include the y- and z-polarized fractions of the first light L1.

The second light L2 can be filtered by the vertical polarization member 220, thereby forming the third light L3 propagating toward the phase compensation layer 400. Because the vertical polarization member 220 absorbs the z-polarized fraction of the second light L2, the third light L3 can include the y-polarized fraction of the first light L1.

The phase compensation layer 400 can retard the phase of the third light L3 by the compensation phase difference. Thus, the fourth light L4 with a delayed phase can propagate from the phase compensation layer 400 toward the liquid crystal display panel 300. In other words, due to the presence of the phase compensation layer 400, the fourth light L4 can have the delayed phase compared to the third light L3.

The liquid crystal display panel 300 can retard the phase of the fourth light L4. Thus, the fifth light L5 with a delayed phase can propagate from the liquid crystal display panel 300 toward the first polarization member 100. Because the fourth light L4 goes through the liquid crystal molecule LM at the angle, the fourth light L4 can have a phase delayed by refractive index anisotropy of the liquid crystal molecule LM. However, the phase delay caused by the liquid crystal molecule LM can be compensated by the compensation phase difference. Accordingly, the fifth light L5 can be a linearly-polarized light that has a polarization substantially parallel to the y-axis.

The first polarization member 100 can substantially prevent the fifth light L5 from being propagated to the outside. In other words, because the fifth light L5 is composed of the y-polarized fraction, it can be absorbed by the first polarization member 100.

As a result, when the image display 1000 displays the black tone image, a lateral light leakage can be substantially prevented. In general, the lateral light leakage can result from the anisotropy in the refractive index of the liquid crystal molecule LM and from the presence of the first and second absorption axes.

According to example embodiments, the second polarization member 200 can be formed to have the third absorption axis substantially perpendicular to the first and second absorption axes. Because of this, the second polarization member 200 can substantially prevent light leakage from occurring by the first and second absorption axes. For example, when light is incident into the second polarization member 200, the presence of the third absorption axis makes it possible to absorb the z-polarized fraction. Accordingly, the presence of the third absorption axis makes it possible to absorb light leakage, which results from a change in the viewing angle and distortion of the first and second absorption axes.

As a result, the light leakage caused by the liquid crystal molecule LM can be substantially prevented by only the negative C plate.

Thus, it is possible to substantially prevent the lateral light leakage from occurring, thereby improving the viewing angle and the display quality of the liquid crystal display 1000. Furthermore, at least two phase compensation layers are used in typical technologies, but example embodiments, can use a single negative C plate. Thus, the number of the phase compensation layers 400 can be reduced, thereby simplifying the fabrication process and reducing the cost of the liquid crystal display 1000.

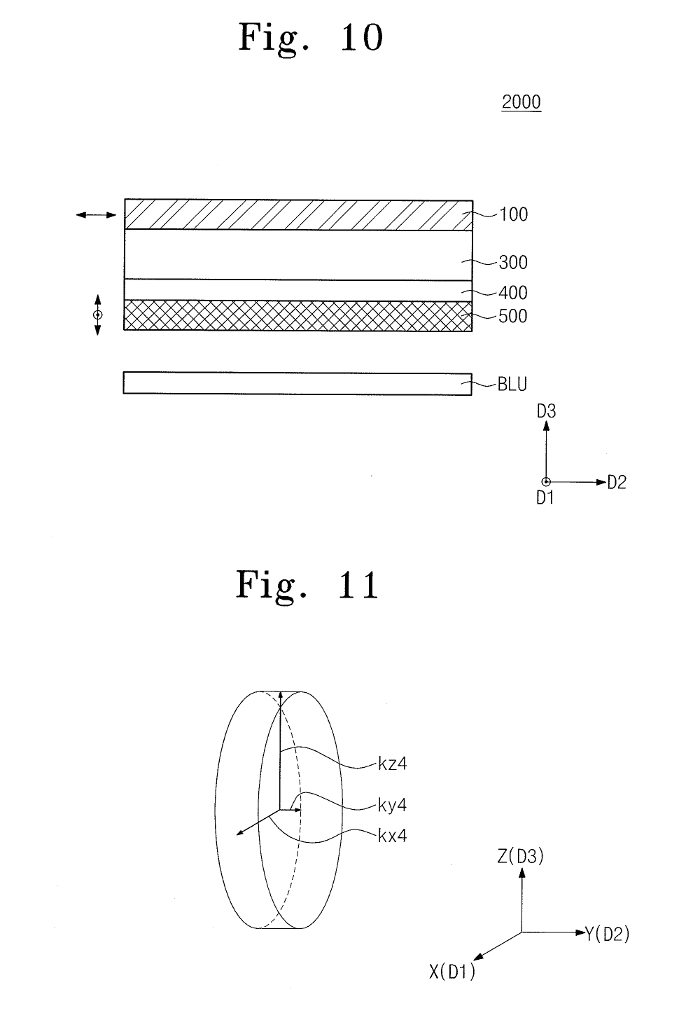

FIG. 10 is a sectional view of a liquid crystal display 2000 according to another example embodiment. In the following description of FIG. 10, a previously described element can be identified by a similar or identical reference number without repeating an overlapping description thereof, for the sake of brevity.

The liquid crystal display 2000 can display an image and include the first polarization member 100, a second polarization member 500, the liquid crystal display panel 300, the phase compensation layer 400, and the backlight unit BLU.

The second polarization member 500, the phase compensation layer 400, the liquid crystal display panel 300, and the first polarization member 100 can be sequentially stacked along the third direction D3. In other words, the first polarization member 100 can be formed on the liquid crystal display panel 300, the phase compensation layer 400 can be formed below the liquid crystal display panel 300, and the second polarization member 500 can be formed below the phase compensation layer 400.

The light transmitted from the backlight unit BLU can be used to display the image on the liquid crystal display panel 300. For example, the image can be displayed using the light passing through the second polarization member 500, the liquid crystal display panel 300, and the first polarization member 100.

The disposition or arrangement of the first polarization member 100, the second polarization member 500, and the phase compensation layer 400 is not limited to the aforementioned example and be variously modified. For example, the second polarization member 500 can be formed on the liquid crystal display panel 300. The phase compensation layer 400 can be interposed between the liquid crystal display panel 300 and the second polarization member 500. The first polarization member 100 can be formed below the liquid crystal display panel 300. In this case, the light transmitted from the backlight unit BLU can be incident on the liquid crystal display panel 300 through the first polarization member 100 and be emitted through the second polarization member 500 so as to display the image.

The second polarization member 500 can receive the light transmitted from the backlight unit BLU and allow the x-polarized fraction of the light so as to be transmitted toward the phase compensation layer 400.

The second polarization member 500 can have a second absorption axis substantially parallel to the y-axis and a third absorption axis substantially parallel to the z-axis. In other words, the second polarization member 500 can absorb y- and z-polarized fractions of the incident light substantially parallel to the second and third absorption axes, respectively, and pass the x-polarized fraction.

FIG. 11 is a schematic diagram provided to explain an extinction coefficient of a disc-like polarizer.

Hereinafter, the second polarization member 500 and the disc-like polarizer will be described with reference to FIGS. 1 and 11.

The second polarization member 500 can include the disc-like polarizer.

The disc-like polarizer can be formed at least partially of, for example, supramolecular complex or several organic compounds.

A fourth x-axis extinction coefficient kx4, a fourth y-axis extinction coefficient ky4, and a fourth z-axis extinction coefficient kz4 will be used to denote x-, y-, and z-components of extinction coefficient of the disc-like polarizer.

The fourth x-axis extinction coefficient kx4 and the fourth z-axis extinction coefficient kz4 can be greater than the fourth y-axis extinction coefficient ky4. Accordingly, most of the x- and z-polarized fractions of light, which can be incident to the second polarization member 500, can be absorbed by the disc-like polarizer.

By contrast, because the fourth y-axis extinction coefficient ky4 is small, the y-polarized fraction of the incident light disc-like can be substantially neglected.

Although not illustrated, the second polarization member 500 can include the protection member and the supporting member. The protection member can be formed on at least one of surfaces of the second polarization member 500, and thus, it can substantially prevent the second polarization member 500 from being polluted or damaged by the environment.

The supporting member can be formed on top and bottom surfaces, respectively, of the second polarization member 500 so as to support the second polarization member 500.

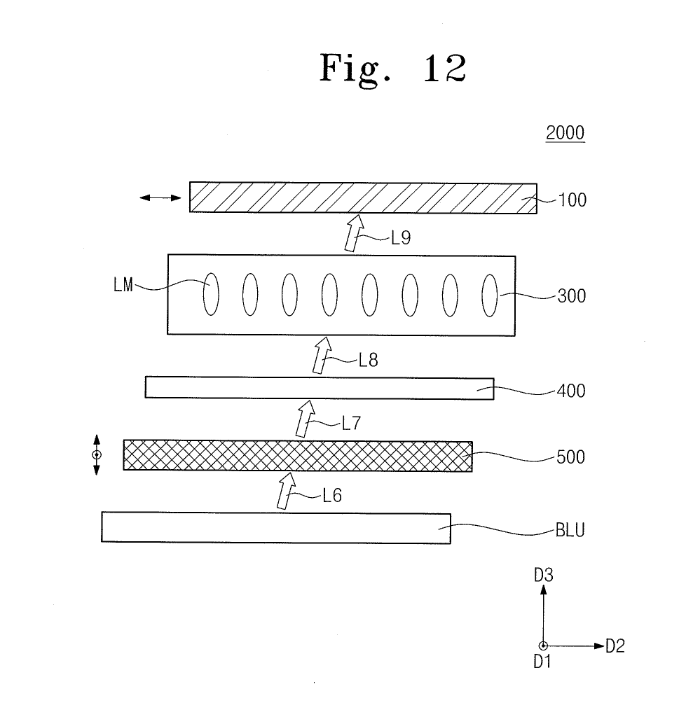

FIG. 12 is an exploded sectional view illustrating the liquid crystal display 2000 of FIG. 10.

The liquid crystal display 2000 in operation will be described with reference to FIGS. 10 through 12.

The liquid crystal display 2000 can display the black tone image. When the liquid crystal display 2000 displays the black tone image, the liquid crystal molecules LM can be arranged in such a way that longitudinal axis thereof is substantially parallel to the z-axis.

The user can be positioned to see the image an angle. In other words, the user can be positioned on a slanted path at an angle in respect to the third direction D3 so as to see the image. In this case, the user can see the image displayed through the sixth to ninth lights L6-L9. The sixth to ninth lights L6-L9 can propagate along the slanted path.

The sixth light L6 can be a light emitted from the backlight unit BLU. The sixth light L6 can be incident into the second polarization member 500 at the angle. The sixth light L6 can be the unpolarized light, which is composed of a rapidly varying succession of different polarization states (e.g., linearly-polarized states and circularly-polarized states).

The sixth light L6 can be filtered by the second polarization member 500, thereby forming the seventh light L7 propagating toward the phase compensation layer 400. Because the second polarization member 500 absorbs the x- and z-polarized fractions of the sixth light L6, the seventh light L7 can include the y-polarized fraction of the sixth light L6.

The phase compensation layer 400 can retard the phase of the seventh light L7 by the compensation phase difference and transmit the eighth light L8 toward the liquid crystal display panel 300. In other words, because of the presence of the phase compensation layer 400, the eighth light L8 can have the delayed phase compared to the seventh light L7.

The liquid crystal display panel 300 can receive the eighth light L8 and output the ninth light L9 propagating toward the first polarization member 100. The eighth light L8 can be at the angle when it passes through the liquid crystal molecule LM. Thus, the phase of the eighth light L8 can be delayed by the anisotropy in the refractive index of the liquid crystal molecule LM. However, the phase delay caused by the liquid crystal molecule LM can be compensated by the compensation phase difference, which can be caused by the phase compensation layer 400. Accordingly, the ninth light L9 can include a y-polarized fraction of light.

The first polarization member 100 can substantially prevent the ninth light L9 from being propagated to the outside. In other words, because the ninth light L9 is composed of the y-polarized fraction, it can be absorbed by the first polarization member 100.

As a result, when the image display 2000 displays the black tone image, the lateral light leakage can be substantially prevented.

However, according to example embodiments, the second polarization member 200 can be formed to have the third absorption axis substantially perpendicular to the first and second absorption axes. Thus, it is possible to substantially suppress light leakage resulting from the first and second absorption axes. For example, the z-polarized fraction can be absorbed by the second polarization member 200. Accordingly, the presence of the third absorption axis makes it possible to absorb the light leakage.

As a result, the light leakage caused by the liquid crystal molecule LM can be substantially prevented by the single negative C plate.

In conclusion, it is possible to substantially prevent the lateral light leakage from occurring, thereby improving the viewing angle and display quality of the liquid crystal display 2000. Furthermore, at least two phase compensation layers are used in the typical art, but according to example embodiments of the described technology, by using a single negative C plate, it is possible to substantially prevent the light leakage. Thus, the number of the phase compensation layers 400 can be reduced, thereby simplifying the fabrication process and reducing the cost of the liquid crystal display 2000.

According to example embodiments of the described technology, the liquid crystal display can include the second polarization member, which has first and second absorption axes and a third absorption axis substantially perpendicular thereto, and the phase compensation layer. The presence of the first and second absorption axes can result in the light leakage, but such light leakage can be absorbed by the second polarization member with the third absorption axis. Thus, the light leakage caused by the liquid crystal layer can be substantially prevented by using the phase compensation layer.

While example embodiments of the inventive concepts have been particularly shown and described, it will be understood by one of ordinary skill in the art that variations in form and detail can be made therein without departing from the spirit and scope of the attached claims.

What is claimed is:

1. A liquid crystal display (LCD), comprising:
a first polarization member having a first absorption axis substantially parallel to a first direction;
a second polarization member formed below the first polarization member, wherein the second polarization member has a second absorption axis substantially parallel to a second direction and a third absorption axis substantially parallel to a third direction, wherein the second direction is substantially perpendicular to the first direction, and wherein the third direction is substantially perpendicular to the first and second directions;
a liquid crystal layer interposed between the first and second polarization members, wherein the liquid crystal layer includes substantially vertically-oriented liquid crystal molecules;
a phase compensation layer interposed between the first and second polarization members; and
a backlight unit configured to provide light towards the liquid crystal layer.

2. The LCD of claim 1, wherein the second polarization member comprises a horizontal polarization member having the second absorption axis and a vertical polarization member having the third absorption axis.

3. The LCD of claim 2, wherein the first polarization member comprises a first polarizer,
wherein the horizontal polarization member comprises a second polarizer,
wherein the vertical polarization member comprises a third polarizer, and
wherein each of the first through third polarizers is a rod-like polarizer.

4. The LCD of claim 3, wherein the first polarizer is configured to satisfy the relationship of ky1>kx1≈kz1, wherein kx1, ky1, and kz1 are components in the first to third directions, respectively, of the extinction coefficient of the first polarizer,
wherein the second polarizer is configured to satisfy the relationship of kx2>ky2≈kz2, wherein kx2, ky2, and kz2 are components in the first to third directions, respectively, of the extinction coefficient of the second polarizer, and wherein the third polarizer is configured to satisfy the relationship of kz3>kx3≈ky3, wherein kx3, ky3, and kz3 are components in the first to third directions, respectively, of the extinction coefficient of the third polarizer.

5. The LCD of claim 2, wherein the second polarization member is closer to the backlight unit than the first polarization member, and the wherein liquid crystal layer is configured to receive the light from the backlight unit through the second polarization member.

6. The LCD of claim 5, wherein the horizontal polarization member is formed closer the backlight unit than the vertical polarization member, and wherein the vertical polarization member is interposed between the horizontal polarization member and the liquid crystal layer.

7. The LCD of claim 5, wherein the vertical polarization member is closer to the backlight unit than the horizontal polarization member, and wherein the horizontal polarization member is interposed between the vertical polarization member and the liquid crystal layer.

8. The LCD of claim 2, wherein the first polarization member is closer to the backlight unit than the second polarization member, and wherein the liquid crystal layer is configured to receive the light from the backlight unit through the first polarization member.

9. The LCD of claim 1, wherein the second polarization member comprises a disc-like polarizer.

10. The liquid crystal display of claim 9, wherein the disc-like polarizer is configured to satisfy the relationship of kx1≈kz1>ky1, and wherein kx1, ky1, and kz1 are components in the first to third directions, respectively, of the extinction coefficient of the disc-like polarizer.

11. The LCD of claim 9, wherein the second polarization member is closer to the backlight unit than the first polarization member, and wherein the liquid crystal layer is configured to receive the light from the backlight unit through the second polarization member.

12. The LCD of claim 9, wherein the first polarization member is closer to the backlight unit than the second polarization member, and wherein the liquid crystal layer is configured to receive the light from the backlight unit through the first polarization member.

13. The LCD of claim 1, wherein the phase compensation layer is interposed between the second polarization member and the liquid crystal layer.

14. The LCD of claim 1, wherein the phase compensation layer is a uniaxial film.

15. The LCD of claim 14, wherein the uniaxial film is a negative C plate.

16. The LCD of claim 15, wherein the liquid crystal molecule has a negative permittivity.

17. A liquid crystal display (LCD), comprising:
a first polarization member having a first absorption axis substantially parallel to a first direction;
a second polarization member formed below the first polarization member, wherein the second polarization member has a second absorption axis substantially parallel to a second direction and a third absorption axis substantially parallel to a third direction, wherein the second direction is substantially perpendicular to the first direction, and wherein the third direction is substantially perpendicular to the first and second direction;
a liquid crystal layer interposed between the first and second polarization members, wherein the liquid crystal layer includes substantially vertically-oriented liquid crystal molecules; and
a phase compensation layer interposed between the first and second polarization members.

18. The LCD of claim 17, further comprising a backlight unit configured to provide light towards the liquid crystal layer, wherein the phase compensation layer is a uniaxial film, and wherein the uniaxial film is a negative C plate.

19. The LCD of claim 18, wherein the first polarization member comprises a first polarizer,
wherein the second polarization member comprises a horizontal polarization member having the second absorption axis and a vertical polarization member having the third absorption axis,
wherein the horizontal polarization member comprises a second polarizer,
wherein the vertical polarization member comprises a third polarizer, and
wherein each of the first through third polarizers is a rod-like polarizer.

20. LCD of claim 19, wherein the first polarizer is configured to satisfy the relationship of ky1>kx1≈kz1, wherein kx1, ky1, and kz1 are components in the first to third directions, respectively, of the extinction coefficient of the first polarizer,
wherein the second polarizer is configured to satisfy the relationship of kx2>ky2≈kz2, wherein kx2, ky2, and kz2 are components in the first to third directions, respectively, of the extinction coefficient of the second polarizer, and
wherein the third polarizer is configured to satisfy the relationship of kz3>kx3≈ky3, wherein kx3, ky3, and kz3 are components in the first to third directions, respectively, of the extinction coefficient of the third polarizer.
